(19) United States
(12) Patent Application Publication
(10) Pub. No.: US 2026/0084455 A1
(43) Pub. Date: Mar. 26, 2026

(54) BINDING PROCESSING DEVICE AND IMAGE FORMING SYSTEM

(71) Applicant: FUJIFILM Business Innovation Corp., Tokyo (JP)

(72) Inventors: Masashi MATSUMOTO, Kanagawa (JP); Takumi UEGANE, Kanagawa (JP); Kohei HATAKENAKA, Kanagawa (JP)

(73) Assignee: FUJIFILM Business Innovation Corp., Tokyo (JP)

(21) Appl. No.: 19/023,058

(22) Filed: Jan. 15, 2025

(30) Foreign Application Priority Data
Sep. 26, 2024 (JP) 2024-167709

(51) Int. Cl. B42C 1/12; B65H 37/04

(52) U.S. Cl. CPC B42C 1/12; B65H 37/04; B65H 2301/5161

(57) ABSTRACT

A binding processing device includes: a paper support unit that supports a paper bundle; a pressing unit that presses the paper bundle; and a binding processing unit that performs binding processing by moving binding teeth toward the paper bundle to apply pressure to the paper bundle, the binding processing unit moving from a binding position of the paper bundle while the paper bundle is being pressed by the pressing unit.

### CROSS-REFERENCE TO RELATED APPLICATIONS

This application is based on and claims priority under 35 USC 119 from Japanese Patent Application No. 2024-167709 filed Sep. 26, 2024.

### BACKGROUND

### (i) Technical Field

The present invention relates to a binding processing device and an image forming system.

### (ii) Related Art

JP2015-139959A discloses a paper binding device of a pressure binding type that binds a paper bundle using a pair of pressure bonding members, in which a surface roughness of the pair of pressure bonding members and/or a static frictional force with paper is made different between the pair of pressure bonding members.

### SUMMARY

There is a technique of performing binding processing on a paper bundle by using binding teeth having protrusions and recesses to clamp the paper bundle and apply pressure. Here, for example, in a case where an amount of moisture contained in the paper bundle is large when pressure is applied to the paper bundle, an amount of elongation of the paper increases due to moisture bonding, which may cause the paper bundle to become deeply embedded in the binding teeth, resulting in a malfunction where the paper bundle cannot be released.

Aspects of non-limiting embodiments of the present disclosure relate to a binding processing device and an image forming system that suppress movement of a paper bundle, which has been subjected to binding processing, dragged by binding teeth, without being affected by characteristics of the paper bundle.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a binding processing device including: a paper support unit that supports a paper bundle; a pressing unit that presses the paper bundle; and a binding processing unit that performs binding processing by moving binding teeth toward the paper bundle to apply pressure to the paper bundle, the binding processing unit moving from a binding position of the paper bundle while the paper bundle is being pressed by the pressing unit.

### BRIEF DESCRIPTION OF THE DRAWINGS

Exemplary embodiment(s) of the present invention will be described in detail based on the following figures, wherein:

FIG. 1 is a diagram showing an overall configuration of an image forming system in the present exemplary embodiment;

FIG. 2 is an explanatory view illustrating a first post-processing device;

FIG. 3 is an explanatory view illustrating a binding processing unit;

FIG. 4 is an explanatory view illustrating vertical movement of a movable roller;

FIG. 5 is a view of a paper accumulation unit as viewed from above; and

FIG. 6 is a flowchart illustrating an operation of binding processing in the present exemplary embodiment.

### DETAILED DESCRIPTION

Hereinafter, exemplary embodiments of the present disclosure will be described in detail with reference to the accompanying drawings.

### Configuration of Image Forming System

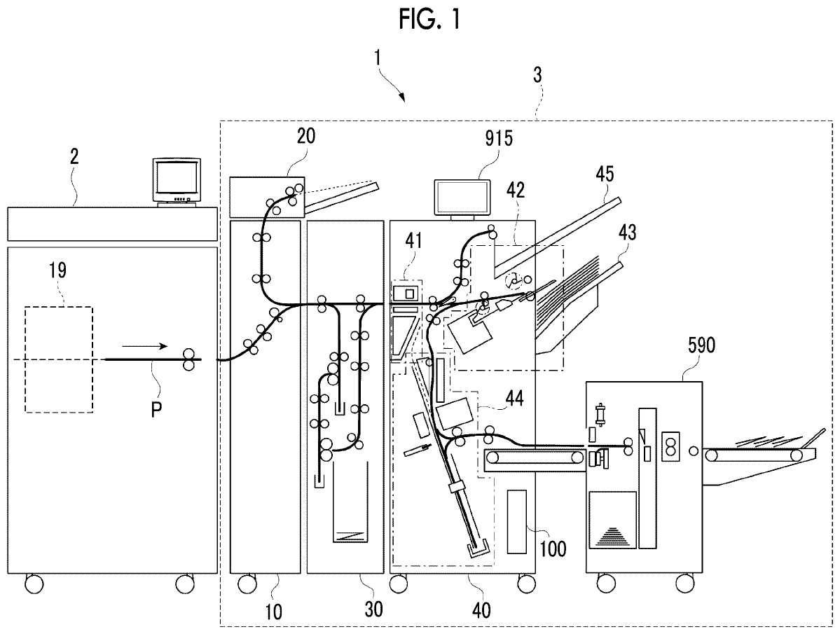

FIG. 1 is a diagram showing an overall configuration of an image forming system 1 in the present exemplary embodiment.

The image forming system 1 shown in FIG. 1 includes an image forming apparatus 2 that forms an image on paper P, and a paper processing apparatus 3 that performs predetermined processing on the paper P on which the image is formed by the image forming apparatus 2.

The image forming apparatus 2 includes an image forming unit 19 that forms an image on the paper P using an electrophotographic method or an ink jet method. The paper P on which the image is formed by the image forming unit 19 of the image forming apparatus 2 is transported toward the paper processing apparatus 3 that is a post-processing apparatus.

The paper processing apparatus 3 includes a transport device 10 that transports the paper P output from the image forming apparatus 2 to the downstream side, and a laminated sheet feed device 20 that feeds laminated sheets such as thick sheets or windowed sheets to the paper P transported by the transport device 10.

Additionally, the paper processing apparatus 3 includes a folding device 30 that performs folding processing such as inward tri-fold (C-fold) or outward tri-fold (Z-fold) on the paper P transported from the transport device 10.

In addition, the paper processing apparatus 3 includes a first post-processing device 40 that is provided downstream of the folding device 30 and that performs hole punching, end binding, saddle binding, or the like on the paper P.

That is, the first post-processing device 40 that performs processing on a paper bundle consisting of a plurality of sheets of paper P on which the image is formed by the image forming apparatus 2 or that performs processing on the paper P for each sheet of paper is provided downstream of the folding device 30.

Additionally, the paper processing apparatus 3 includes a second post-processing device 590 that is provided downstream of the first post-processing device 40 and that further performs processing on the paper bundle that is saddle-folded or saddle-bounded.

Further, the paper processing apparatus 3 includes an information processing unit 100 that includes a central processing unit (CPU) executing a program and that controls the entire paper processing apparatus 3.

In addition, the paper processing apparatus 3 includes an information display unit 915 that is configured as a liquid crystal monitor or the like and that displays information to a user.

The first post-processing device 40 includes a perforation unit 41 that performs hole punching (punching) on the paper P and an end binding unit 42 that binds an end of the paper bundle.

Additionally, the first post-processing device 40 includes a first stacking portion 43 on which the paper bundle subjected to the processing by the end binding unit 42 is stacked. The first stacking portion 43 is an example of a paper bundle stacking member for discharge.

Further, the first post-processing device 40 includes a second stacking portion 45 on which the paper P that is not processed by the first post-processing device 40 or the paper P that has only been hole-punched is stacked.

Furthermore, the first post-processing device 40 includes a saddle binding unit 44 that performs saddle folding/saddle binding on the paper bundle to create a spread-format booklet.

### First Post-Processing Device

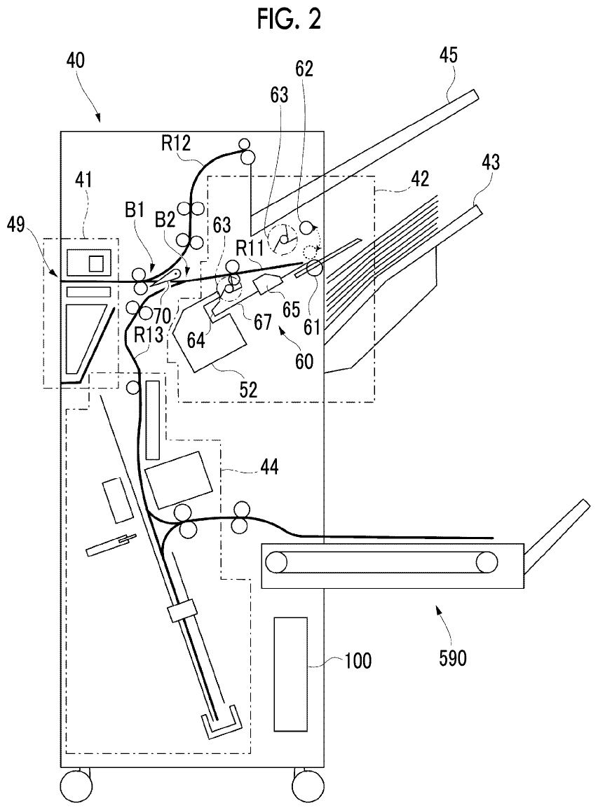

FIG. 2 is an explanatory view illustrating the first post-processing device 40.

The first post-processing device 40 includes a receiving inlet 49 for receiving the paper P transported from the folding device 30.

Additionally, the first post-processing device 40 includes the perforation unit 41 immediately after the receiving inlet 49. The perforation unit 41 performs hole punching (punching) such as two-hole or four-hole punching on the paper P transported to the first post-processing device 40.

In addition, the first post-processing device 40 includes a first paper transport path R11 from the receiving inlet 49 to the end binding unit 42.

The first paper transport path R11 is used to transport the paper P received by the receiving inlet 49 to the end binding unit 42.

Further, the first post-processing device 40 includes a second paper transport path R12 that branches from the first paper transport path R11 at a first branch portion B1.

The second paper transport path R12 is used to transport the paper P to the second stacking portion 45.

Furthermore, the first post-processing device 40 includes a third paper transport path R13 that branches from the first paper transport path R11 at a second branch portion B2.

The third paper transport path R13 is used to transport the paper P to the saddle binding unit 44.

Additionally, the first post-processing device 40 includes a switching gate 70 that switches a transport destination of the paper P to any of the first paper transport path R11 to the third paper transport path R13.

The end binding unit 42 is provided with a paper accumulation unit 60 that accumulates a required number of sheets of paper P to generate the paper bundle. The paper accumulation unit 60 is an example of a paper support unit.

The paper accumulation unit 60 includes a support plate 67 that is disposed to be inclined with respect to a horizontal direction and that supports the transported paper P from below. In the present exemplary embodiment, the paper bundle is generated on the support plate 67.

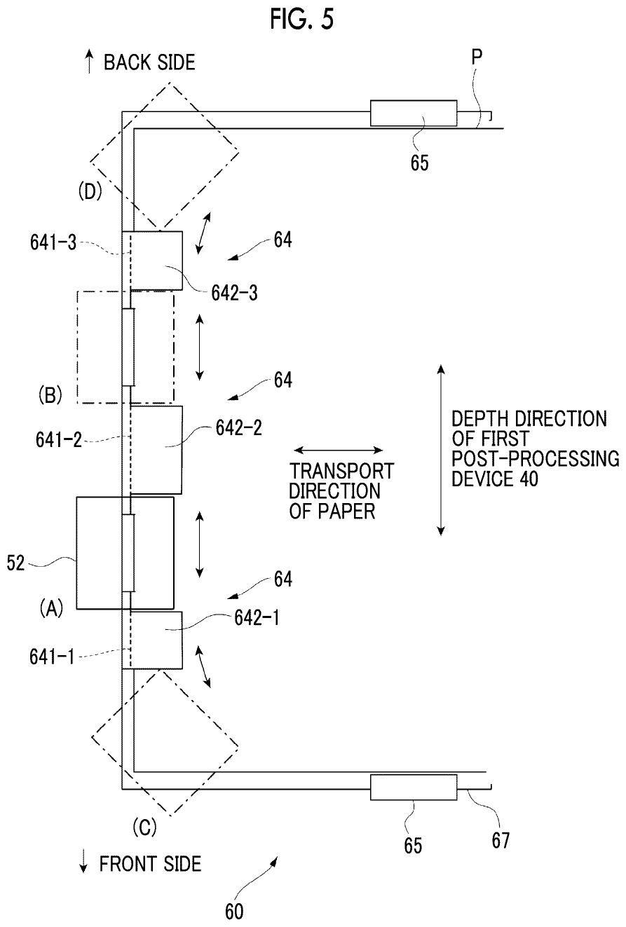

In addition, the support plate 67 includes an end guide 64 that aligns the position of an end portion of the paper P in a transport direction. More specifically, the end guide 64 includes a restricting portion 641 and a facing piece 642 (refer to FIG. 5).

The restricting portions 641 (641-1, 641-2, and 641-3) are disposed to be orthogonal to the support plate 67. The end portion of the paper P in the transport direction abuts against the restricting portion 641, thereby restricting the movement of the paper P.

Further, the facing pieces 642 (642-1, 642-2, and 642-3) are connected to the restricting portions 641 and are disposed to face the support plate 67. In the present exemplary embodiment, in a case where the paper P is placed on the support plate 67, the end portion of the paper P in the transport direction enters between the facing piece 642 and the support plate 67.

Additionally, the end binding unit 42 is provided with a paper alignment member 65 that aligns the position of the paper P in a width direction of the paper P. Here, the width direction of the paper P refers to a width of the paper P in a direction intersecting a direction in which the paper P is transported in the paper accumulation unit 60.

In the present exemplary embodiment, two paper alignment members 65 are provided, one paper alignment member 65 is disposed on one side of the paper bundle in the width direction, and the other paper alignment member 65 is disposed on the other side of the paper bundle in the width direction.

The paper alignment member 65 includes, for example, a drive source such as a motor, and can move in the width direction of the paper P (paper bundle).

In the present exemplary embodiment, each time the paper P is supplied onto the support plate 67, end portions of the paper P in the width direction are pressed by the paper alignment members 65, and the position of the paper P (paper bundle) in the width direction is aligned.

Further, the end binding unit 42 is provided with a binding processing unit 52 that executes binding (end binding) on the end portion of the paper bundle generated in the paper accumulation unit 60. In the present exemplary embodiment, the binding processing unit 52 performs binding processing without using a staple needle. The binding processing unit 52 is an example of a binding processing unit.

### Binding Processing Unit

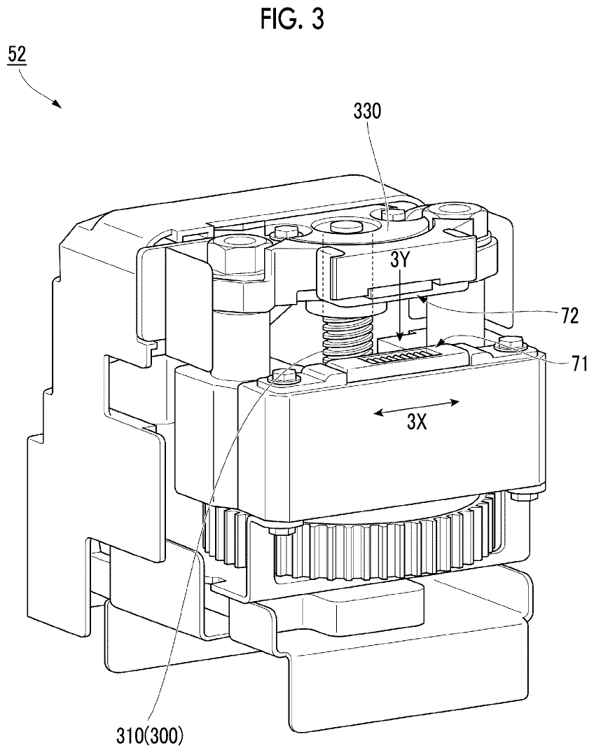

FIG. 3 is an explanatory view illustrating the binding processing unit 52.

The binding processing unit 52 includes first binding teeth 71 used for the binding processing of the paper bundle. In addition, the binding processing unit 52 includes second binding teeth 72 above the first binding teeth 71. Hereinafter, in a case where the first binding teeth 71 and the second binding teeth 72 are not distinguished, the first binding teeth 71 and the second binding teeth 72 may be referred to as binding teeth.

The first binding teeth 71 and the second binding teeth 72 each include a protrusion and recess portion.

More specifically, the first binding teeth 71 include a protrusion and recess portion in which protrusion portions and recess portions are alternately arranged in a direction indicated by an arrow 3X in the drawing on a surface positioned on a second binding teeth 72 side.

Additionally, the second binding teeth 72 include a protrusion and recess portion in which protrusion portions and recess portions are alternately arranged in the direction indicated by the arrow 3X in the drawing on a surface positioned on a first binding teeth 71 side.

In other words, the first binding teeth 71 include the protrusion and recess portion in which the protrusion portions and the recess portions are alternately arranged in a longitudinal direction on the surface positioned on the second binding teeth 72 side.

Further, the second binding teeth 72 include the protrusion and recess portion in which the protrusion portions and the recess portions are alternately arranged in the longitudinal direction on the surface positioned on the first binding teeth 71 side.

In the present exemplary embodiment, the first binding teeth 71 and the second binding teeth 72 are each configured such that the protrusion portions and the recess portions are alternately arranged, but the protrusion portions and the recess portions may be arranged in other configurations.

In addition, the binding processing unit 52 includes a moving mechanism 300 that moves the second binding teeth 72 toward the first binding teeth 71.

Further, the moving mechanism 300 includes a rod-shaped screw member 310 extending along the vertical direction in the drawing.

Moreover, the second binding teeth 72 include an interlocking portion 330 that meshes with the screw member 310.

The moving mechanism 300 rotates the screw member 310 in a circumferential direction to move the interlocking portion 330 and the second binding teeth 72 toward the first binding teeth 71.

That is, in the present exemplary embodiment, in a case where the drive motor (not shown) provided in the binding processing unit 52 is rotated in a forward direction, the screw member 310 is rotated in the circumferential direction and in one direction.

As a result, the interlocking portion 330 and the second binding teeth 72 move downward along a linear path indicated by an arrow 3Y in the drawing and move toward the first binding teeth 71.

In the present exemplary embodiment, the paper bundle (not shown) positioned between the first binding teeth 71 and the second binding teeth 72 is clamped and pressure-applied between the first binding teeth 71 and the second binding teeth 72.

In this case, the recess portions provided in the first binding teeth 71 and the protrusion portions provided in the second binding teeth 72 face each other. Additionally, the protrusion portions provided in one binding teeth enter the recess portions provided in the other binding teeth. As a result, the sheets of paper P that constitute the paper bundle are pressure-bonded to each other, and the binding processing of the paper P is performed.

After the binding processing ends, the drive motor is reversed, and the screw member 310 rotates in an opposite direction.

Consequently, the interlocking portion 330 and the second binding teeth 72 move upward. In a case where the second binding teeth 72 move upward, the second binding teeth 72 are separated from the first binding teeth 71.

In the present exemplary embodiment, a configuration has been employed in which the screw member 310 is used to move the second binding teeth 72, but a mechanism that moves the second binding teeth 72 is not particularly limited. Other mechanisms such as a cam mechanism or a jack mechanism may be used.

In addition, in the present exemplary embodiment, the second binding teeth 72 are moved, but the first binding teeth 71 may also be moved, or both the first binding teeth 71 and the second binding teeth 72 may be moved.

The description returns to FIG. 2, and the end binding unit 42 will be further described.

The end binding unit 42 is provided with a transport roller 61 that performs rotational drive to send the paper bundle generated in the paper accumulation unit 60 to the first stacking portion 43.

Additionally, the end binding unit 42 is provided with a movable roller 62 that is movable to a position in pressure contact with the transport roller 61 or a position retracted from the transport roller 61. The transport roller 61 and the movable roller 62 function as a pressing unit that presses the paper bundle. The movable roller 62 is in a non-contact state with the paper bundle at a position retracted from the transport roller 61 and does not hinder the movement of the paper bundle.

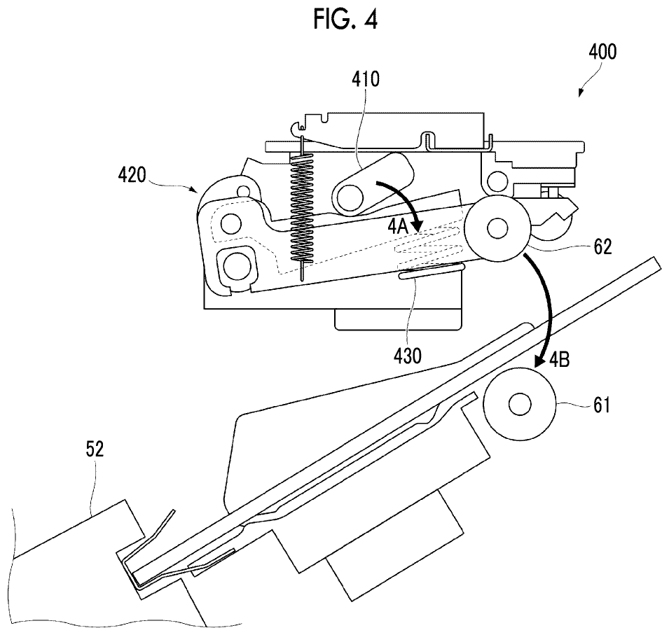

FIG. 4 is an explanatory view illustrating the vertical movement of the movable roller 62.

The movable roller 62 is moved to a position in pressure contact with the transport roller 61 or is moved to a position retracted from the transport roller 61 by a vertical movement mechanism 400 (not shown in FIG. 2).

The vertical movement mechanism 400 includes a push-down member 410 that pushes down a relay mechanism 420, the relay mechanism 420 to which the movable roller 62 is connected, and a biasing member 430 for applying pressure to the paper bundle.

The push-down member 410 is moved in a direction indicated by an arrow 4A in FIG. 4 by the forward rotation of a motor (not shown) provided in the vertical movement mechanism 400 and comes into contact with the relay mechanism 420. Further, the push-down member 410 presses the relay mechanism 420 and pushes down the relay mechanism 420.

In a case where the relay mechanism 420 is pushed down, the movable roller 62 connected to the relay mechanism 420 moves in a direction indicated by an arrow 4B. Consequently, the movable roller 62 moves to a position in pressure contact with the transport roller 61. The biasing member 430 supplies a pressure-applying force to the movable roller 62 in a case where the movable roller 62 presses the paper bundle.

In a case where the movable roller 62 is retracted from the transport roller 61, the motor provided in the vertical movement mechanism 400 is reversed, thereby moving the push-down member 410 in a direction opposite to the direction indicated by the arrow 4A.

As a result, the pressing against the relay mechanism 420 is released, and the movable roller 62 moves to a position retracted from the transport roller 61.

The description returns to FIG. 2, and the processing by the end binding unit 42 will be described.

In a case where the processing by the end binding unit 42 is performed, first, the transported paper P is received by the receiving inlet 49. The paper P is then transported along the first paper transport path R11 and reaches the end binding unit 42.

Then, the paper P is transported up to above the support plate 67 and then falls onto the support plate 67. Additionally, the paper P is supported from below by the support plate 67 and slides on the support plate 67 due to the inclination of the support plate 67 and a rotating member 63.

The paper P then abuts against the end guide 64 attached to an end portion of the support plate 67. Consequently, the movement of the paper P is stopped. Subsequently, this operation is performed each time the paper P is transported from the upstream side, and the paper bundle in which a plurality of sheets of paper P are aligned is generated on the support plate 67.

In a case where a predetermined number of sheets of paper P are stacked on the support plate 67, the binding processing unit 52 executes binding on the end portion of the paper bundle. The binding processing unit 52 executes binding by clamping the paper bundle between two binding teeth and pressure-bonding the sheets of paper P that constitute the paper bundle.

The movable roller 62 then advances toward the transport roller 61, and the paper bundle is clamped between the movable roller 62 and the transport roller 61. Then, the transport roller 61 performs rotational drive, and the paper bundle is transported to the first stacking portion 43.

A configuration may also be employed in which, in a case where the paper bundle is transported, the movable roller 62 is rotationally driven to transport the paper bundle to the first stacking portion 43. Alternatively, a configuration may be employed in which both the transport roller 61 and the movable roller 62 are rotationally driven to transport the paper bundle to the first stacking portion 43.

Next, the movement of the binding processing unit 52 on the paper accumulation unit 60 will be described.

FIG. 5 is a view of the paper accumulation unit 60 as viewed from above.

The binding processing unit 52 in the present exemplary embodiment is provided to be movable with respect to the paper accumulation unit 60. The binding processing unit 52 moves in a direction intersecting the transport direction of the paper P. The binding processing unit 52 can also be said to move along a depth direction (direction from a back side and a front side) of the first post-processing device 40. As a result, the binding processing unit 52 can perform the binding processing on the paper bundle at a plurality of locations.

The binding processing unit 52 stops at, for example, two points (an (A) position and a (B) position in FIG. 5) that are positioned at different locations in the depth direction of the first post-processing device 40 and performs the binding processing at the two points.

Additionally, the binding processing unit 52 stops at, for example, one end of the paper bundle (one corner portion of the paper bundle) shown at a (C) position in FIG. 5 and performs the binding processing at the one point.

Further, the binding processing unit 52 stops at, for example, the other end of the paper bundle (the other corner portion of the paper bundle) shown at a (D) position in FIG. 5 and performs the binding processing at the one point.

The binding positions shown above, that is, the (A) position to the (D) position, are examples of the binding position, and the binding position is not limited thereto.

The binding processing unit 52 in the present exemplary embodiment performs linear movement between the (A) position and the (B) position.

In addition, the binding processing unit 52 moves between the (A) position and the (C) position and between the (B) position and the (D) position while, for example, rotating by 45°. The binding processing unit 52 in the present exemplary embodiment includes, for example, a drive source such as a motor and can perform the movement mentioned above. Further, for example, a configuration may also be employed in which a movable belt member is provided, the binding processing unit 52 is attached to the belt member, and the binding processing unit 52 is moved in accordance with the movement of the belt member.

In the present exemplary embodiment, as shown in FIG. 5, the paper accumulation unit 60 includes a plurality of end guides 64. The end guides 64 are disposed at different locations in the depth direction of the first post-processing device 40. The number of end guides 64 shown in FIG. 5 is an example and is not limited thereto.

First, in a case where the binding processing is performed at the (A) position of FIG. 5, the binding processing is performed through a gap formed between the facing piece 642-1 positioned on the front side and the facing piece 642-2 positioned at a center portion.

Additionally, in a case where the binding processing is performed at the (B) position of FIG. 5, the binding processing is performed through a gap formed between the facing piece 642-2 positioned on a center side and the facing piece 642-3 positioned on the back side.

In the present exemplary embodiment, a case where the binding processing unit 52 that does not use a binding member such as a staple is used as the binding processing unit 52 has been described as an example, but an additional binding processing unit that uses the binding member such as the staple may be provided.

In a case where the additional binding processing unit that uses the binding member is provided, for example, the binding processing unit to be used for the binding is switched in response to an instruction from the user. In this case, both binding processing without using the binding member and binding processing using the binding member can be performed.

In the present exemplary embodiment, a maximum distance between the first binding teeth 71 and the second binding teeth 72 is larger than a height dimension of the end guide 64. As a result, the binding processing unit 52 can pass through the end guide 64.

### Flow of Binding Processing in the Present Exemplary Embodiment

Next, a flow of the binding processing in the present exemplary embodiment will be described.

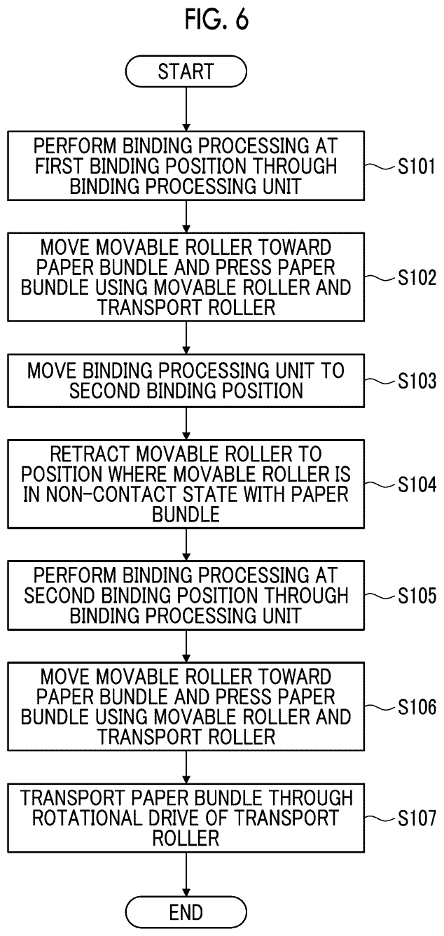

FIG. 6 is a flowchart illustrating an operation of the binding processing in the present exemplary embodiment. This processing is executed by the information processing unit 100 that controls each operation of the first post-processing device 40. Additionally, here, a case where the binding processing unit 52 accepts an instruction for two-location binding to perform the binding processing on the paper bundle at two locations is shown.

The binding processing unit 52 waits at the (A) position as the first binding position shown in FIG. 5 as the initial position. In a case where the instruction to perform the binding processing is accepted, the binding processing unit 52 first performs the binding processing at the first binding position (S101). More specifically, the second binding teeth 72 advance toward the first binding teeth 71 to apply pressure to the paper bundle. This applied pressure causes the first binding teeth 71 and the second binding teeth 72 to embed into the paper bundle. By applying pressure while clamping the paper bundle, the fibers of each sheet of paper intertwine, and the paper bundle is bound.

In such binding processing, the second binding teeth 72 advance toward the first binding teeth 71 to apply pressure to the paper bundle, and then the second binding teeth 72 are separated from the first binding teeth 71. However, for example, in a case where the moisture content of the paper bundle is high during pressure application, the increased amount of elongation of the paper due to moisture bonding causes the paper bundle to become embedded in the protrusions and recesses of the teeth, resulting in the paper bundle not being separable. After the binding processing has ended at the first binding position, there is a need to move the binding processing unit 52 to the second binding position, but in a case where the paper bundle is embedded in the protrusions and recesses of the teeth, the paper bundle may be dragged and moved by the first binding teeth 71 and/or the second binding teeth 72.

Therefore, in the present exemplary embodiment, after the binding processing of the paper bundle by the first binding teeth 71 and the second binding teeth 72 has been performed, the movable roller 62 moves toward the paper bundle to come into contact with the paper bundle, and the paper bundle is pressed by the movable roller 62 and the transport roller 61 (S102). That is, the movable roller 62 and the transport roller 61 that are the pressing unit in the present exemplary embodiment are in a contact state with the paper bundle after the binding processing has been performed by the binding processing unit 52.

Next, the binding processing unit 52 starts moving to the (B) position as the second binding position (S103). In this case, the movable roller 62 and the transport roller 61 are in contact with the paper bundle and are in a state of pressing the paper bundle. That is, the binding processing unit 52 moves from the first binding position to the second binding position while the paper bundle is being pressed by the movable roller 62 and the transport roller 61. In this case, the embedding of the binding teeth into the paper bundle at the previous binding position is loosened and released; however, since the paper bundle is being pressed by the movable roller 62 and the transport roller 61, the movement of the paper bundle dragged by the binding teeth of the binding processing unit 52 is suppressed.

In a case where the binding processing unit 52 moves to the second binding position, the movable roller 62 is retracted to a position where the movable roller 62 transitions from a contact state with the paper bundle to a non-contact state (S104).

Then, the binding processing unit 52 causes the second binding teeth 72 to advance toward the first binding teeth 71 to apply pressure to the paper bundle at the second binding position and performs the binding processing (S105).

Then, after the binding processing has been performed by the binding processing unit 52 at the second binding position, the movable roller 62 moves toward the paper bundle again to come into contact with the paper bundle, and the paper bundle is pressed by the movable roller 62 and the transport roller 61 (S106).

Then, the paper bundle is transported to the first stacking portion 43 by the rotational drive of the transport roller 61 (S107). In this case, the embedding of the binding teeth into the paper bundle at the second binding position is loosened and released by the rotational drive of the roller.

In a case where the transport of the paper bundle to the first stacking portion 43 ends, the transport roller 61 stops the rotational drive, and the movable roller 62 returns to the initial position. Consequently, a series of operations of the binding processing ends.

In a case where the paper bundle is transported to the first stacking portion 43, a configuration may be employed in which both the transport roller 61 and the movable roller 62 are rotationally driven, or one of the transport roller 61 or the movable roller 62 is rotationally driven.

As described above, the movable roller 62 and the transport roller 61 are originally used for a function of transporting the paper bundle to the first stacking portion 43 on the downstream side. However, in the present exemplary embodiment, the movable roller 62 and the transport roller 61 have the additional function of pressing the paper bundle in a case where the binding processing unit 52 moves to the second binding position after the binding processing at the first binding position. That is, the movable roller 62 and the transport roller 61 that are the pressing unit come into contact with the paper bundle and transport the paper bundle in the discharge direction, after all the binding processing by the binding processing unit 52 that is the binding processing unit has ended. However, even in a case where the binding processing unit 52 moves from the first binding position to the second binding position, the movable roller 62 and the transport roller 61 remain in contact with the paper bundle, but do not perform transport in the discharge direction and only serve as the function of pressing the paper bundle.

In the present exemplary embodiment, in a case where the binding processing unit 52 moves from the first binding position to the second binding position, the movable roller 62 and the transport roller 61 press the paper bundle, thereby suppressing the movement of the paper bundle dragged by the binding processing unit 52.

Here, in addition to or instead of the pressing by the movable roller 62 and the transport roller 61, pressing using the paper alignment member 65 can also suppress the movement of the paper bundle dragged by the binding processing unit 52.

The paper alignment member 65 presses the end portion of the paper P in the width direction and aligns the position of the paper P (paper bundle) in the width direction, as mentioned above.

Therefore, in the present exemplary embodiment, in a case where the binding processing unit 52 moves from the first binding position to the second binding position, the paper alignment member 65 comes into contact with the paper bundle and presses the paper bundle.

More specifically, in the present exemplary embodiment, in a case where the binding processing unit 52 moves from the first binding position to the second binding position, the paper alignment member 65 presses the end portion of the paper bundle and limits the movement of the paper bundle.

The paper alignment member 65 is movable in the width direction of the paper P (paper bundle) by the drive source such as a motor, as mentioned above. Therefore, in a case where the binding processing unit 52 moves from the first binding position to the second binding position, for example, a current value for exciting the paper alignment member 65 is increased to enhance position holding properties of the paper alignment member 65. As a result, even in a case where the paper bundle is fixed at the aligned position and the paper bundle is embedded in the binding teeth due to the pressure applied at the first binding position, the paper bundle is not dragged and moved by the movement of the binding processing unit 52 to the second binding position and is released from the binding teeth.

In the present exemplary embodiment, a case where an instruction for two-location binding is accepted has been described as an example, but the present exemplary embodiment can also be applied to a case where the number of locations where the binding processing is to be performed is one or two or more.

Although the exemplary embodiments of the present disclosure have been described above, a technical scope of the exemplary embodiment of the present disclosure is not limited to the above-described exemplary embodiments. Other various modifications and alternative configurations that do not deviate from the scope of the technical concept of the exemplary embodiments of the present disclosure are included in the present disclosure.

### Supplementary Note

(((1)))

A binding processing device comprising:
a paper support unit that supports a paper bundle;
a pressing unit that presses the paper bundle; and
a binding processing unit that performs binding processing by moving binding teeth toward the paper bundle to apply pressure to the paper bundle, the binding processing unit moving from a binding position of the paper bundle while the paper bundle is being pressed by the pressing unit.
   (((2)))

The binding processing device according to (((1))),
wherein the pressing unit is in a contact state with the paper bundle after the binding processing has been performed by the binding processing unit.
   (((3)))

The binding processing device according to (((1))) or (((2))),
wherein the pressing unit is positioned in a non-contact state with the paper bundle while the binding processing is being performed by the binding processing unit.
   (((4)))

The binding processing device according to any one of (((1))) to (((3))),
wherein the pressing unit moves toward the paper bundle from a non-contact state and comes into contact with the paper bundle after the binding processing has been performed by the binding processing unit.
   (((5)))

The binding processing device according to any one of (((1))) to (((4))),
wherein the pressing unit is retracted to a position where the pressing unit is in a non-contact state with the paper bundle in a case where the binding processing unit moves from a binding portion.
   (((6)))

The binding processing device according to any one of (((1))) to (((5))),
wherein the pressing unit moves the paper bundle to a paper bundle stacking member for discharge by rotating in a contact state with the paper bundle.
   (((7)))

The binding processing device according to any one of (((1))) to (((6))),
wherein the binding processing unit performs the binding processing at a first binding position on the paper bundle and then moves to a second binding position to perform the binding processing, and
the pressing unit comes into contact with the paper bundle in a case where the binding processing unit moves from the first binding position to the second binding position.
   (((8)))

The binding processing device according to any one of (((1))) to (((7))),
wherein the pressing unit transports the paper bundle in a discharge direction by coming into contact with the paper bundle after all the binding processing by the binding processing unit has ended, and does not perform transport in the discharge direction upon contact with the paper bundle in a case where the binding processing unit moves from a first binding position to a second binding position.
   (((9)))

The binding processing device according to any one of (((1))) to (((8))), further comprising:
a paper alignment member that aligns a position of a paper in a width direction of the paper that is a direction intersecting a direction in which the paper is transported to the paper support unit,
wherein the paper alignment member restricts movement of the paper bundle by coming into contact with the paper bundle in a case where the binding processing unit moves from a first binding position to a second binding position.
   (((10)))

An image forming system comprising:
an image forming apparatus that forms an image on paper; and
the binding processing device according to any one of (((1))) to (((9))) that binds the paper on which the image is formed by the image forming apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A binding processing device comprising:
a paper support unit that supports a paper bundle;
a pressing unit that presses the paper bundle; and
a binding processing unit that performs binding processing by moving binding teeth toward the paper bundle to apply pressure to the paper bundle, the binding processing unit moving from a binding position of the paper bundle while the paper bundle is being pressed by the pressing unit.

2. The binding processing device according to claim 1,
wherein the pressing unit is in a contact state with the paper bundle after the binding processing has been performed by the binding processing unit.

3. The binding processing device according to claim 2,
wherein the pressing unit is positioned in a non-contact state with the paper bundle while the binding processing is being performed by the binding processing unit.

4. The binding processing device according to claim 3,
wherein the pressing unit moves toward the paper bundle from a non-contact state and comes into contact with the paper bundle after the binding processing has been performed by the binding processing unit.

5. The binding processing device according to claim 4,
wherein the pressing unit is retracted to a position where the pressing unit is in a non-contact state with the paper bundle in a case where the binding processing unit moves from a binding portion.

6. The binding processing device according to claim 5,
wherein the pressing unit moves the paper bundle to a paper bundle stacking member for discharge by rotating in a contact state with the paper bundle.

7. The binding processing device according to claim 1,
wherein the binding processing unit performs the binding processing at a first binding position on the paper bundle and then moves to a second binding position to perform the binding processing, and
the pressing unit comes into contact with the paper bundle in a case where the binding processing unit moves from the first binding position to the second binding position.

8. The binding processing device according to claim 7,
wherein the pressing unit transports the paper bundle in a discharge direction by coming into contact with the paper bundle after all the binding processing by the binding processing unit has ended, and does not perform transport in the discharge direction upon contact with the paper bundle in a case where the binding processing unit moves from a first binding position to a second binding position.

9. The binding processing device according to claim 7, further comprising:
a paper alignment member that aligns a position of a paper in a width direction of the paper that is a direction intersecting a direction in which the paper is transported to the paper support unit,
wherein the paper alignment member restricts movement of the paper bundle by coming into contact with the paper bundle in a case where the binding processing unit moves from a first binding position to a second binding position.

10. An image forming system comprising:
an image forming apparatus that forms an image on paper; and
the binding processing device according to claim 1 that binds the paper on which the image is formed by the image forming apparatus.

11. An image forming system comprising:
an image forming apparatus that forms an image on paper; and
the binding processing device according to claim 2 that binds the paper on which the image is formed by the image forming apparatus.

12. An image forming system comprising:
an image forming apparatus that forms an image on paper; and
the binding processing device according to claim 3 that binds the paper on which the image is formed by the image forming apparatus.

13. An image forming system comprising:
an image forming apparatus that forms an image on paper; and
the binding processing device according to claim 4 that binds the paper on which the image is formed by the image forming apparatus.

14. An image forming system comprising:
an image forming apparatus that forms an image on paper; and
the binding processing device according to claim 5 that binds the paper on which the image is formed by the image forming apparatus.

15. An image forming system comprising:
an image forming apparatus that forms an image on paper; and
the binding processing device according to claim 6 that binds the paper on which the image is formed by the image forming apparatus.

16. An image forming system comprising:
an image forming apparatus that forms an image on paper; and
the binding processing device according to claim 7 that binds the paper on which the image is formed by the image forming apparatus.

17. An image forming system comprising:
an image forming apparatus that forms an image on paper; and
the binding processing device according to claim 8 that binds the paper on which the image is formed by the image forming apparatus.

18. An image forming system comprising:
an image forming apparatus that forms an image on paper; and
the binding processing device according to claim 9 that binds the paper on which the image is formed by the image forming apparatus.
